(19) United States
(12) Patent Application Publication
(10) Pub. No.: US 2021/0333911 A1
(43) Pub. Date: Oct. 28, 2021

(54) Touch Display Device

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Mingjun ZHOU, Shenzhen, Guangdong (CN)

(21) Appl. No.: 16/615,695

(22) PCT Filed: Oct. 30, 2019
(86) PCT No.: PCT/CN2019/114429

§ 371 Date: Jan. 28, 2021

(30) Foreign Application Priority Data
Jul. 19, 2019 (CN) 201910654370.X

(51) Int. Cl. G06F 3/041; B32B 3/30; B32B 7/14

(52) U.S. Cl. CPC G06F 3/0412; B32B 3/30; B32B 2307/416; B32B 2457/208; B32B 7/14

(57) ABSTRACT

The touch display device includes a display panel, a touch panel positioned on the display panel, a first glue layer positioned at an edge of the touch panel as a ring shape, a cover plate positioned on the first plastic layer, and a micro structure layer positioned at one side of the cover plate, for performing antiglare function. A middle of the first glue layer forms a vacuum cavity.

### FIELD OF THE INVENTION

The present invention relates to display field, and more particularly to a touch display device.

### BACKGROUND OF THE INVENTION

In the recent years, the development of the display device and touch device is rapid. A conventional touch display device comprises a stacked display panel, touch panel and cover plate. However, after the vacuum pasting process is performed, there is a vacuum cavity between the cover plate and the touch panel. The vacuum cavity has a negative pressure such that the cover plate is bended toward the vacuum cavity. This makes the thickness of the cover plate uneven because the cover plate is strengthened due to the force. The difference thickness enormously influences the light path so that the user may notice a rainbow mura and thus the visual effect is ruined.

Therefore, a novel touch display device is required to overcome the above defects.

### SUMMARY OF THE INVENTION

One objective of an embodiment of the present invention is to provide a touch display device. The touch display device comprises: a display panel; a touch panel, positioned on the display panel; a first glue layer, positioned at an edge of the touch panel as a ring shape, wherein a middle of the first glue layer forms a vacuum cavity; a cover plate, positioned on the first plastic layer; and a micro structure layer, positioned at one side of the cover plate, for performing antiglare function.

Furthermore, the micro structure layer has a diffuse reflection surface, which is rough and uneven such that the antiglare function is performed.

Furthermore, the micro structure layer is positioned on a surface of the cover plate, which is facing the touch panel.

Furthermore, the micro structure layer is positioned on a surface of the touch panel, and the surface is facing the cover plate.

Furthermore, the micro structure layer is positioned on a surface of the touch panel, and the surface is back on to the cover plate.

Furthermore, the micro structure layer comprises an antiglare film.

Furthermore, the micro structure layer comprises a substrate, wherein the antiglare film is positioned on the substrate.

Furthermore, the touch display device further comprises a second glue layer, positioned between the display panel and the touch panel.

Furthermore, the touch display device further comprises an antiglare layer, positioned on a surface of the cover plate, wherein the surface is back on to the touch panel.

Furthermore, the antiglare layer comprises a light blocking layer, and the light blocking layer is distributed according to the first glue layer.

The present invention provides a touch display device, in which a micro structure layer is positioned between a cover plate and a touch panel. The micro structure layer has a diffuse reflection surface, which is rough and uneven such that the antiglare function is performed and the rainbow mura is improved. The overall visual effect of the touch display device is also improved.

### BRIEF DESCRIPTION OF THE DRAWINGS

FIG. 1 is a diagram of a touch display device according to a first embodiment of the present invention.

FIG. 2 is a diagram of a micro structure layer according to the first embodiment of the present invention.

FIG. 3 is a diagram of a touch display device according to a second embodiment of the present invention.

FIG. 4a is a diagram of a touch display device according to a third embodiment of the present invention.

FIG. 4b is a diagram of another touch display device according to the third embodiment of the present invention.

FIG. 5a is a diagram of a touch display device according to a fourth embodiment of the present invention.

FIG. 5b is a diagram of another touch display device according to the fourth embodiment of the present invention.

Elements illustrated in the above figures are labeled as:

1 display panel; 2 touch panel; 3 first glue layer; 4 cover plate; 5 micro structure layer; 6 second glue layer; 7 antiglare layer; 31 vacuum cavity; 51 antiglare film; 52 substrate; 71 light blocking layer; 100 touch display device.

### DETAILED DESCRIPTION OF PREFERRED EMBODIMENTS

The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Embodiment 1

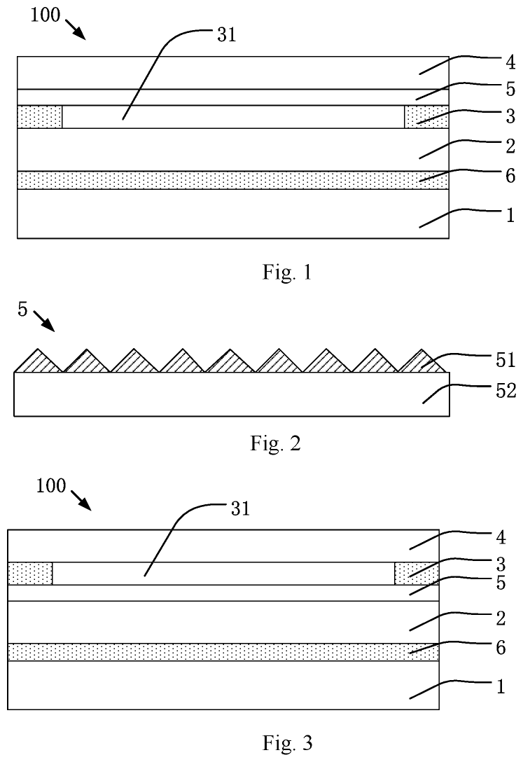

As shown in FIG. 1, a touch display device 100 is provided. The touch display device 100 comprises a display panel 1, a touch panel 2, a first glue layer 3, a cover plate 4, and a micro structure layer 5.

The display panel 1 is implemented with an LCD display panel, OLED display panel, an active matrix OLED display panel, or a PLED display panel.

The touch panel 2 is positioned on the upper surface of the display panel 1. The shape and the size of the touch panel 2 are the same as the shape and the size of the display panel 1. This could make the operable region of the touch panel 2 and the operable region of the display panel 1 consistent.

The first glue layer 3 is in a ring shape and positioned at the edge of the upper surface of the touch panel 2. The first glue layer 3 surrounds the upper surface of the touch panel and thus forms a vacuum cavity. In this embodiment, the first glue layer 3 is preferably a rectangular ring and the vacuum cavity 31 is in the middle of rectangular ring. The first glue layer 3 is positioned between the cover plate 4 and the touch panel 2. The first glue layer 3 is positioned at the edge of the side of the cover plate 4, where the side is facing the touch panel 2.

The first glue 3 is implemented with a liquid glue or a solid glue, such as optical liquid glue or optical solid glue. Specifically, the first glue 3 could comprises a material containing PU or silicone. The first glue layer 3 is comparatively high adhesive to fix the corresponding position of the cover plate 4 and the touch panel 2.

The cover plate 4 is positioned on the upper surface of the touch panel. In this embodiment, the cover plate 4 is a glass cover plat. The cover plate 4 is used to protect the touch panel 2 and the display panel 1. A user could touch or click the cover plate 4 to control the entire device. The touch panel 2 is positioned correspondingly to the cover plate 4 such that the operable region of the touch panel 2 and the operable region of the display panel 1 are the same.

In order to improve the display effect, a micro structure layer 5 is included in this embodiment. The micro structure layer 5 has a diffuse reflection surface, which is rough and uneven such that the antiglare function is performed. The surface haze of the micro structure layer 5 is more than 10%. The micro structure layer 5 is positioned at one side of the cover plate. In this embodiment, the micro structure layer 5 is positioned at the side of the cover plate, which is facing the touch panel 2.

As shown in FIG. 2, the micro structure layer 5 comprises an antiglare film 51, which is the above mentioned rough and uneven diffuse reflection surface. The antiglare film is a transparent thin film for reducing glares on the display/panel. The glare is caused by the reflection light of the panel and may make the user have headache or sore eyes and reduce his work efficiency. The antiglare film 51 is often implemented by hazing the hard coat (HC) material (a transparent film through a hard coat process). The reflection lights become blurred due to diffuse reflection mechanism such that the antiglare function could be performed. The hazing process comprises eroding the surface of the film to form a rough and uneven diffuse reflection surface such that the antiglare film 51 could be formed. The rough and uneven diffuse reflection surface of the antiglare film 51 could improve the interferences of the reflection lights. In this embodiment, the material of the antiglare film 51 could be optical plastic, polymethyl methacrylate (PMMA), polyethylene terephthalate (PET), or Polystyrene (PS). The surface haze of the micro structure layer 5 is more than 10%.

In this embodiment, the antiglare film 51 is made by hazing the surface of the cover plate 4 that is facing the touch panel 2. The hazing process comprises eroding the surface of the film to form the antiglare film 51. The micro structure 5 could effectively improve the reflection light interferences.

As shown in FIG. 2, the micro structure layer comprises a substrate 52. The antiglare film 51 is positioned on the substrate 52. The substrate 52 allows the micro structure layer 5 to be pasted on the cover plate through the substrate 5. Therefore, this embodiment does not limit the way of forming the micro structure layer 5 to be performing the hazing process on the cover plate. The above-mentioned method is easy and could save process time.

The material of the substrate 52 could be the same of the antiglare film 51. It could comprise optical plastic, polymethyl methacrylate (PMMA), polyethylene terephthalate (PET), or Polystyrene (PS). The antiglare film 51 is formed by the hazing process on the substrate 52. The hazing process comprises eroding the surface of the film to form a rough and uneven diffuse reflection surface. In this way, the antiglare film 51 and the substrate 52 are an integrated structure.

The touch display device 100 further comprises a second glue layer 6. The second glue layer 6 is positioned between the display panel 1 and the touch panel 2. The second glue layer 6 realizes the pasting of the display panel 1 and the touch panel 2. The second glue layer 6 is a solid optically clear adhesive, which is a glue that could be solidified by humidity and UV light. The above-mentioned solidified glue has very good weather resistance and anti-extension and anti-explosion performances. This enormously improves the display device's safety, reliability, endurance and appearance. The second glue layer 6 also has high adhesive strength, low haze, low shrinkage, and high yellow resistance. It could be used in the pasting field of large size computer, LCD display or any other integrated devices.

As shown in FIG. 3, the second embodiment has all features of the first embodiment. The difference is: the micro structure layer 5 of the second embodiment is positioned on the surface of the touch panel, which is facing the cover plate. In contrast, the micro structure layer 5 is positioned on the surface of the cover plate 4, which is facing the touch panel. The micro structure layer 5 could effectively improve the reflection light interferences.

As shown in FIG. 2, the micro structure layer comprises an antiglare filme 51 and a substrate 52. The antiglare film 51 is positioned on the substrate 52. The substrate 52 allows the micro structure layer 5 to be pasted on the cover plate through the substrate 5. Therefore, this embodiment does not limit the way of forming the micro structure layer 5 to be performing the hazing process on the cover plate. The above-mentioned method is easy and could save process time.

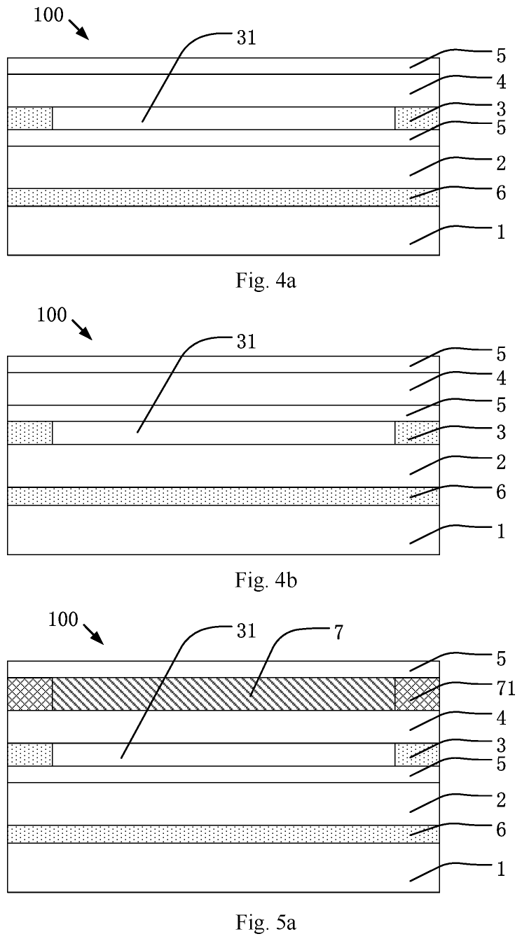

As shown in FIGS. 4a and 4b, the third embodiment has all features of the first embodiment. The difference is: another micro structure layer 5 is positioned on the surface of the cover plate 4, which is back on to the touch panel 2, in order to improve the visual effect.

The micro structure layer 5 could be positioned both at the top and the bottom of the cover plate 4. Two micro structure layers 5 are positioned such that the haze between the touch panel 2 and cover plate 4 could be more than 10% and the haze above the cover plate 4 could be more than 17%. In this way, the haze of the display device 100 could be increased and thus the antiglare effect is improved.

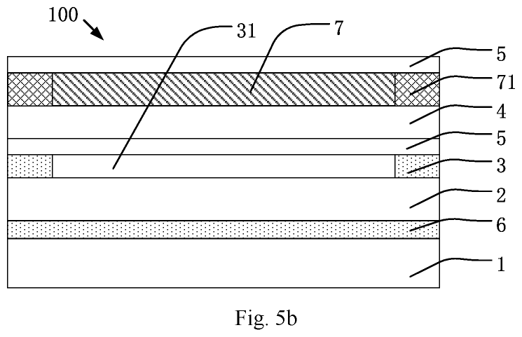

As shown in FIGS. 5a and 5b, the fourth embodiment has all features of the third embodiment. The difference is: the touch display device 100 further comprises an antiglare layer 7 in order to improve the visual effect. The antiglare layer 7 is positioned on the surface of the cover plate 4, which is back on to the touch panel 2. That is, the antiglare layer 7 is positioned between the cover plate 4 and the uppermost micro structure layer 5.

FIG. 5a and FIG. 5b are diagrams showing two structures according to the fourth embodiment. The difference is: the micro structure layer 5 is positioned on the surface of the touch panel 2, which is facing the cover plate 4 in FIG. 5a. In contrast, in FIG. 5b, the micro structure layer 5 is positioned on the surface of the the cover plate 4, which is facing the touch panel 2.

The material of the antiglare layer 7 comprises an optical plastic, preferably PMMA, PET or PS. The antiglare layer 7 has a certain haze, which could be between 5% and 40%. This could further increase the haze of the touch display device 100 and thus improves the antiglare effect.

The antiglare layer 7 further comprises a light blocking layer 71. The location of the light blocking layer is corresponding to the location of the first glue layer 3. That is, the light blocking layer 71 could also be a ring structure. The material of the light blocking layer 71 is non-transparent material, such as black ink, black resistor for locking peripheral circuits (not shown) of the touch panel 2. The light blocking layer 71 could be formed on the antiglare layer 7 through a coating or printing process. The light blocking layer 71 could have a certain width, such as 10-30 nm. The light blocking layer 71 could bare the force due to the negative pressure of the vacuum cavity 31 and thus reduce the force on the cover plate 4 from the vacuum cavity 31. This could prevent the rainbow mura because the light blocking layer 71 reduces the bending condition.

In addition, in the condition that the micro structure layer 5 only comprises the antiglare film 51, the antiglare film 51 could be formed by performing a hazing process on the surface of the cover plate 4, which is back on to the antiglare layer 7. The hazing process comprises eroding the surface of the film to form the antiglare film 51. The micro structure 5 could effectively increase the haze of the touch display device and thus further realize the antiglare function.

The present invention provides a touch display device, in which a micro structure layer is positioned between a cover plate and a touch panel. The micro structure layer has a diffuse reflection surface, which is rough and uneven such that the antiglare function is performed and the rainbow mura is improved. The overall visual effect of the touch display device is also improved.

Above are embodiments of the present invention, which does not limit the scope of the present invention. Any modifications, equivalent replacements or improvements within the spirit and principles of the embodiment described above should be covered by the protected scope of the invention.

What is claimed is:

1. A touch display device comprising:
a display panel;
a touch panel, positioned on the display panel;
a first glue layer, positioned at an edge of the touch panel as a ring shape, wherein a middle of the first glue layer forms a vacuum cavity;
a cover plate, positioned on the first plastic layer; and
a micro structure layer, positioned at one side of the cover plate, for performing antiglare function.

2. The touch display device of claim 1, wherein the micro structure layer has a diffuse reflection surface, which is rough and uneven such that the antiglare function is performed.

3. The touch display device of claim 1, wherein the micro structure layer is positioned on a surface of the cover plate, which is facing the touch panel.

4. The touch display device of claim 1, wherein the micro structure layer is positioned on a surface of the touch panel, and the surface is facing the cover plate.

5. The touch display device of claim 1, wherein the micro structure layer is positioned on a surface of the touch panel, and the surface is back on to the cover plate.

6. The touch display device of claim 1, wherein the micro structure layer comprises an antiglare film.

7. The touch display device of claim 6, wherein the micro structure layer comprises a substrate, wherein the antiglare film is positioned on the substrate.

8. The touch display device of claim 1, further comprising:
a second glue layer, positioned between the display panel and the touch panel.

9. The touch display device of claim 1, further comprising:
an antiglare layer, positioned on a surface of the cover plate, wherein the surface is back on to the touch panel.

10. The touch display device of claim 9, wherein the antiglare layer comprises a light blocking layer, and the light blocking layer is distributed according to the first glue layer.
